(19) United States
(12) Patent Application Publication
(10) Pub. No.: US 2014/0231008 A1
(43) Pub. Date: Aug. 21, 2014

(54) MOISTURE CURABLE HOT MELT ADHESIVE

(71) Applicant: Henkel AG & Co. KGAA, Duesseldorf (DE)

(72) Inventor: Yongxia Wang, Bridgewater, NJ (US)

(73) Assignee: Henkel AG & Co. KGAA, Duesseldorf (DE)

(21) Appl. No.: 14/262,063

(22) Filed: Apr. 25, 2014

Related U.S. Application Data
(63) Continuation of application No. 11/961,345, filed on Dec. 20, 2007, now abandoned.

(51) Int. Cl. C09J 175/04; C09J 123/30; C09J 133/12

(52) U.S. Cl. CPC C09J 175/04; C09J 133/12; C09J 123/30
USPC 156/331.7; 525/131; 525/125

(57) ABSTRACT

Moisture curable hot melt adhesive compositions that contain functionally modified polyolefins and have improved green strength before set are prepared without using added crystalline polyester polyol.

### FIELD OF THE INVENTION

The invention relates to a novel moisture curable hot melt adhesive which contains a functionally modified polyolefin.

### BACKGROUND OF THE INVENTION

Hot melt adhesives are solid at room temperature but, upon application of heat, melt to a liquid or fluid state in which form they are applied to a substrate. On cooling, the adhesive regains its solid form. The hard phase(s) formed upon cooling the adhesive imparts all of the cohesion (strength, toughness, creep and heat resistance) to the final adhesive. Curable hot melt adhesives, which are also applied in molten form, cool to solidify and subsequently cure by a chemical crosslinking reaction. An advantage of hot melt curable adhesives over traditional liquid curing adhesives is their ability to provide “green strength” upon cooling prior to cure. Advantages of hot melt curable adhesives over non-curing hot melt adhesives include improved temperature and chemical resistance.

The majority of reactive hot melts are moisture-curing urethane adhesives. These adhesives consist primarily of isocyanate terminated polyurethane prepolymers that react with surface or ambient moisture in order to chain-extend, forming a new polyurethane/urea polymer. Polyurethane prepolymers are conventionally obtained by reacting polyols with isocyanates. Cure is obtained through the diffusion of moisture from the atmosphere or the substrates into the adhesive, and subsequent reaction. The reaction of moisture with residual isocyanate forms carbamic acid. This acid is unstable, decomposing into an amine and carbon dioxide. The amine reacts rapidly with isocyanate to form a urea. The final adhesive product is a crosslinked material polymerized primarily through urea groups and urethane groups.

Additives are commonly included in reactive hot melt adhesive formulations. It is particularly advantageous to incorporate low cost additives that would provide improved properties, such as improved green strength before solidification and increased cure speed. Green strength before set is especially important for reactive hot melt adhesives because it enables the adhesive to yield handling bond strength immediately after application while maintaining desirable open and set times. Fast cure speed allows formulation components to be utilized more quickly. High green strength, long open times and fast cure speed are especially advantageous in certain moisture reactive hot melt adhesive end use applications, such as panel lamination and product assembly.

There continues to be a need in the art for moisture reactive hot melt adhesives containing low cost additives that result in desirable properties such as improved green strength with long open time. The present invention addresses this need.

### SUMMARY OF THE INVENTION

The invention provides moisture curable reactive hot melt adhesive compositions that contain functionally modified polyolefins. The adhesives of the invention have low viscosity, high green strength, long open/set time, fast moisture cure speed and high heat resistance. The improved properties of the adhesive of the invention can be obtained without the use of crystalline polyester polyols.

One embodiment of the invention is directed to a moisture reactive polyurethane hot melt adhesive composition. The adhesive of the invention comprises an isocyanate, one or more polyols, and one or more functionally modified polyolefins and is substantially free of crystalline polyester polyol. The adhesive may if desired comprise other optional components such as for example one or more thermoplastic materials, and prior to or after formation of the prepolymer, and e.g., tackifier or other desired ingredients.

Another embodiment of the invention is directed to a method for bonding materials together which comprises applying the moisture reactive hot melt adhesive composition of the invention in a liquid form to a first substrate, bringing a second substrate in contact with the composition applied to the first substrate, and subjecting the applied composition to conditions which will allow the composition to cool and cure to an irreversible solid form, said conditions comprising moisture. Included are methods of bonding together substrates in the manufacture of various useful articles, in particular articles or end use applications that require long open time.

Still another embodiment of the invention is directed to an article of manufacture comprising the adhesive of the invention which has been cured.

### BRIEF DESCRIPTION OF THE DRAWING FIGURE

FIG. 1 illustrates improvements in green strength seen in moisture curable hot melt adhesives formulated with a functionally modified polyolefin.

### DETAILED DESCRIPTION OF THE INVENTION

All percents are percent by weight of the adhesive composition, unless otherwise stated.

The term moisture reactive hot melt adhesive, moisture curable/curing hot melt adhesive and moisture curing urethane/polyurethane adhesives are used interchangeable herein. Moisture curing hot melt adhesives consist primarily of isocyanate-capped polyurethane prepolymers obtained by reacting diols (typically polyethers, polyesters and polybutadienes) with a polyisocyanate (most commonly methylene bisphenyl diisocyanate (MDI)). A stoichiometric imbalance of NCO to OH groups is required in order for moisture cure to proceed, cure being obtained through the diffusion of moisture from the atmosphere or the substrates into the adhesive and subsequent reaction of moisture with residual isocyanate.

By “open time” is meant the time between the application of the adhesive to a first substrate and contacting the applied adhesive, with application of necessary pressure to a second substrate.

The term “green strength” is generally used in two ways. “Green strength before set” is the cohesive strength that the adhesive exhibits before it sets. This strength is crucial to hold the bonded substrates tightly together before the adhesive solidifies. For end use applications that require long open time, high “green strength before set” is a must to achieve a good bond. “Green strength after set” is the strength of the adhesive after it sets but before it cures. It can also be referred as set strength.

It has now been discovered that moisture curing polyurethane adhesives that contain, in addition to a polyol and polyisocyanate, a functionally modified polyolefin may be obtained with improved green strength before set. The adhesives of the invention are manufactured without use of added crystalline polyester polyols and are substantially free of crystalline polyester polyol. Among the other improved properties are low viscosity, long open/set time, fast cure rate and low cost, and can be applied using traditional reactive hot melt techniques such as spraying, extruding, roll coating and bead applications.

The reactive hot melt adhesive of the invention is compatible over a wide range of melt viscosities such that it does not perform phase separation, gelling or agglomerating upon packaging, storing or dispensing. While polyester polyol is commonly utilized in reactive hot melt adhesives to provide suitable green strength and open time and set time, the reactive hot melt adhesive of the present invention may be fully utilized without the addition of any polyester polyol. Use of a functionally modified polyolefin provides improved green strength to the formulation and obviates the need for polyester polyol.

The adhesives of the invention comprise an isocyanate component. Non-limiting examples of useful isocyanate components include methyenebisphenyldiisocyanate (MDI), isophoronediisocyanate (IPDI), hydrogenated methylenebisphenyldiisocyanate (HMDI) and toluene diisocyanate (TDI). The isocyanate component is typically used in amounts of from about 5 to about 40 wt %.

The adhesive will also contain a polyol, other than a crystalline polyester polyol. Non-limiting examples include polyether polyols and polybutadienes. The added polyol will typically be used in amounts of from about from about 0.01 to about 70 wt %.

The adhesive of the invention will contain a functionally modified polyolefin, in particular an oxidized polyethylene. The functionally modified polyolefin will typically be used in amounts of from about 0.01 wt % to about 30 wt %.

Other optional components may be added such as thermoplastic resins and/or (meth)acrylic polymers. Such polymers may be blended with the polyol prior to reaction thereof with the isocyanate, or may be added to the isocyanate terminated prepolymer.

The reactive hot melt compositions of the invention are useful in the manufacture of articles made of a wide variety of substrates (materials), including but not limited to wood, metal, polymeric plastics, glass and textiles. Due to its use of different type of raw materials and thus different mechanism of action, the adhesives of the invention are particularly well suited for end use applications that require a long open time such as products that require a large or complex assembly. The adhesives find use in manufacture of consumer products and in specialized industrial applications. Markets where the adhesives find use include textiles (e.g., carpet and clothing), food packaging, footwear, consumer, construction, furniture, automotive and aircraft. Applications include but are not limited to use in water towers, for bonding to exterior surfaces, bonding to wood with high levels of pitch and e.g., in marine and automotive applications, use as a glazing/backbedding compound in the manufacture of windows, use in the manufacture of doors including entry doors, garage doors and the like, use in the manufacture of architectural panels, use in bonding components on the exterior of vehicles, and the like.

Any suitable compound, which contains two or more isocyanate groups, may be used for preparing urethane prepolymers.

Organic polyisocyanates, which may be used to practice the invention, include alkylene diisocyanates, cycloalkylene diisocyanates, aromatic diisocyanates and aliphatic-aromatic diisocyanates. Specific examples of suitable isocyanate-containing compounds include, but are not limited to, ethylene diisocyanate, ethylidene diisocyanate, propylene diisocyanate, butylene diisocyanate, trimethylene diisocyanate, hexamethylene diisocyanate, toluene diisocyanate, cyclopentylene-1,3-diisocyanate, cyclo-hexylene-1,4-diisocyanate, cyclohexylene-1,2-diisocyanate, 4,4′-diphenylmethane diisocyanate, 2,2-diphenylpropane-4,4′-diisocyanate, xylylene diisocyanate, 1,4-naphthylene diisocyanate, 1,5-naphthylene diisocyanate, m-phenylene diisocyanate, p-phenylene diisocyanate, diphenyl-4,4′-diisocyanate, azobenzene-4,4′-diisocyanate, diphenylsulphone-4,4′-diisocyanate, 2,4-tolylene diisocyanate, dichlorohexa-methylene diisocyanate, furfurylidene diisocyanate, 1-chlorobenzene-2,4-diisocyanate, 4,4′,4″-triisocyanatotriphenylmethane, 1,3,5-triisocyanato-benzene, 2,4,6-triisocyanato-toluene, 4,4′-dimethyldiphenyl-methane-2,2′,5,5-tetratetraisocyanate, and the like. While such compounds are commercially available, methods for synthesizing such compounds are well known in the art. Preferred isocyanate-containing compounds are methyenebisphenyldiisocyanate (MDI), isophoronediisocyante (IPDI), hydrogenated MDI (HMDI) and toluene diisocyanate (TDI).

The prepolymer is most commonly prepared by the polymerization of a polyisocyanate with a polyol, most preferably the polymerization of a diisocyanate with a low molecular weight diol. Polyols useful in the practice of the invention include polyhydroxy ethers (substituted or unsubstituted polyalkylene ether glycols or polyhydroxy polyalkylene ethers), the ethylene or propylene oxide adducts of polyols and the monosubstituted esters of glycerol, polyamide polyols, amorphous and liquid polyesters, castor oil and vegetable oils of different molecular weight and functionality, other fatty polyols, polybutadiene diol, polyisobutylene diol as well as mixtures thereof.

Examples of polyether polyols include a linear and/or branched polyether having hydroxyl groups, and contain substantially no functional group other than the hydroxyl groups. Examples of the polyether polyol may include polyoxyalkylene polyol such as polyethylene glycol, polypropylene glycol, polybutylene glycol and the like. Further, a homopolymer and a copolymer of the polyoxyalkylene polyols may also be employed. Particularly preferable copolymers of the polyoxyalkylene polyols may include an adduct at least one compound selected from the group consisting of ethylene glycol, propylene glycol, diethylene glycol, dipropylene glycol, triethylene glycol, 2-ethylhexanediol-1,3,glycerin, 1,2,6-hexane triol, trimethylol propane, trimethylol ethane, tris(hydroxyphenyl)propane, triethanolamine, triisopropanolamine, ethylenediamine and ethanolamine; with at least one compound selected from the group consisting of ethylene oxide, propylene oxide and butylene oxide.

A number of suitable polyols are commercially available. Non-limiting examples include polyethers such as ARCOL PPG 2025 (Bayer), PolyG 20-56 (Arch) and PolyG 30-42 (Arch), polyamide polyols such as PAPOL polyol (Arizona Chemical), amorphous or liquid polyesters such as Dynacoll 7230 (Degussa) and Stepanpol PD-56 (Stepan), and polybutadiene such as PoIyBD R-45HTLO (Sartomer). “Polymer polyols” are also suitable, i.e., graft polyols containing a proportion of a vinyl monomer, polymerized in situ, e.g., Max 34-28 (Union Carbide). Additional polyols include polycaprolactone diols and polycarbonate diols.

Examples of fatty polyols may include castor oil, the products of hydroxylation of unsaturated or polyunsaturated natural oils, the products of hydrogenations of unsaturated or polyunsaturated polyhydroxyl natural oils, polyhydroxyl esters of alkyl hydroxyl fatty acids, polymerized natural oils, soybean polyol, and alkylhydroxylated amides of fatty acids.

The adhesive contains a functionally modified polyolefin. Such component is included in the adhesive to provide an adhesive having advantageous properties such as high green strength before set, low viscosity, fast cure rate and high heat resistance. In addition, the use of functionally modified polyolefins results in a lower cost composition because the inexpensive functionally modified polyolefin obviates the need for a more costly polyester polyol in the composition. Polyolefins such as polyethylene, polypropylene, and ethylenenic copolymers can be modified to have functional groups. The functionality of the functionally modified polyolefins includes hydroxyl, carboxyl, amino, thiol, epoxy, vinyl, silyl, and isocyanate groups. A particularly useful functionally modified polyolefin is oxidized polyethylene. The number average molecular weight of the functionally modified polyolefins is in the range of about 50 to 100,000, more preferably about 100 to 10,000. Non-limiting examples include EE-2 polymer, which is commercially available from Westlake Chemical, and the EPOLENE® series, available from Eastman Chemical Company.

The adhesive may optionally contain a thermoplastic polymer. The thermoplastic polymer may be either a functional or a non-functional thermoplastic. Example of suitable thermoplastic polymers include acrylic polymers, functional acrylic polymers, non-functional acrylic polymers, acrylic block copolymer, acrylic polymer having tertiary-alkyl amide functionality, polysiloxane polymers, polystyrene copolymers, polyvinyl polymers, divinylbenzene copolymers, polyetheramides, polyvinyl acetal, polyvinyl butyral, polyvinyl acetate, polyvinyl chloride, methylene polyvinyl ether, cellulose acetate, styrene acrylonitrile, amorphous polyolefin, olefin block copolymer [OBC], polyolefin plastomer, thermoplastic urethane, polyacrylonitrile, ethylene vinyl acetate copolymer, ethylene vinyl acetate terpolymers, functional ethylene vinyl acetate, ethylene acrylate copolymer, ethylene acrylate terpolymer, ethylene butadiene copolymers and/or block copolymers, styrene butadiene block copolymer, and mixtures thereof.

A number of suitable thermoplastic polymers are commercially available. Non-limiting examples include ethylene vinyl acetate copolymers such as the Elvax® EVA resins (Dupont), ethylene acrylate copolymers such as the Enable™ resins (ExxonMobil), and (meth)acrylic polymers such as the Elvacite® resins (Lucite) and Degalan resins (Degussa).

The urethane prepolymers may also be prepared by the reaction of a polyisocyanate with a polyamino or a polymercapto-containing compound such as diamino polypropylene glycol or diamino polyethylene glycol or polythioethers such as the condensation products of thiodiglycol either alone or in combination with other glycols such as ethylene glycol, 1,2-propylene glycol or with other polyhydroxy compounds disclosed above.

Further, small amounts of low molecular weight dihydroxy, diamino, or amino hydroxy compounds may be used as chain extenders.

While the adhesives may be used directly as described above, if desired the adhesives of the present invention may also be formulated with other conventional additives which are compatible with the composition. Such additives include defoamers, plasticizers, compatible tackifiers, curing catalysts, dissociation catalysts, fillers, rheology modifiers, anti-oxidants, pigments, adhesion promoters, stabilizers, aliphatic C₅-C₁₀ terpene oligomers, bituminous materials and the like. Thixotropic agents, such as fumed silica, may also be added to provide sag resistance. Conventional additives that are compatible with a composition according to this invention may simply be determined by combining a potential additive with the composition and determining if they are compatible. An additive is compatible if it is homogenous within the product. Non-limiting examples of suitable additives include, without limitation, rosin, rosin derivatives, rosin ester, aliphatic hydrocarbons, aromatic hydrocarbons, aromatically modified aliphatic hydrocarbons, terpenes, terpene phenol, modified terpene, high molecular weight hindered phenols and multifunctional phenols such as sulfur and phosphorous-containing phenol, terpene oligomers, DMDEE, silanes, paraffin waxes, microcrystalline waxes and hydrogenated castor oil. The reactive hot melt adhesives of the invention may also contain flame retardant components.

The invention also provides a method for bonding articles together which comprises applying the reactive hot melt adhesive composition of the invention in a liquid melt form to a first article, bringing a second article in contact with the composition applied to the first article, and subjecting the applied composition to conditions which will allow the composition to cool and cure to a composition having an irreversible solid form, said conditions comprising moisture. The composition is typically distributed and stored in its solid form, and is stored in the absence of moisture. When the composition is ready for use, the solid is heated and melted prior to application. Thus, this invention includes reactive polyurethane hot melt adhesive compositions in both its solid form, as it is typically to be stored and distributed, and its liquid form, after it has been melted, just prior to its application.

After application, to adhere articles together, the reactive hot melt adhesive composition is subjected to conditions that will allow it to solidify and cure to a composition that has an irreversible solid form. Solidification (setting) occurs when the liquid melt begins to cool from its application temperature to room temperature. Curing, i.e. chain extending, to a composition that has an irreversible solid form, takes place in the presence of ambient moisture.

The invention is further illustrated by the following non-limiting examples.

### EXAMPLES

In the examples that follow:

PolyG 20-265 is a polyether polyol obtained from Arch Chemicals.

PolyG 20-112 is a polyether polyol obtained from Arch Chemicals.

PolyG 20-56 is a polyether polyol obtained from Arch Chemicals.

EE-2 polymer is an oxidized polyethylene obtained from Westlake Chemical.

Elvacite 2016 is a MMA/n-BMA copolymer obtained from Lucite International.

Mondur M is MDI obtained from Bayer.

Comparative example 2 is a moisture reactive hot melt adhesive that contains polyester polyol and which is commercially available from National Starch and Chemical Company under the tradename PUR-FECT LOK® 34-9014.

### Preparation of Adhesives:

Various formulations of reactive hot melt adhesives were prepared by placing into a clean container the amount of polyether polyols, EE-2 polymer, and MMA/n-BMA copolymer set forth in Table 1. The mixture was then melted at a temperature of 120-140° C. for about 1 to 3 hours. While the mixture was being melted, a 3-hole kettle lid and a stir paddle equipped Glascol heating mantle, which can accommodate the container, was preheated to 120° C. The container was then assemblied into the Glascol heating mantle and vacuum applied to the system for 2 hours with agitation. After breaking the vacuum, MDI was added to the mixture and reacted for about 2-3 hours at a temperature in the range of about 120-140° C. After the reaction, the mixture was degassed and batches drawn off into individual containers.

TABLE 1

| | | | Comparative |
|---|---|---|---|
| | Example | Example | Example |
| | 1 | 2 | 1 |
| PolyG 20-265 | 9.8 | 10.2 | 10.4 |
| PolyG 20-112 | 21.7 | 22.6 | 23.2 |
| Poly G 20-56 | 21.9 | 22.8 | 23.4 |
| EE-2 polymer | 5.0 | 2.0 | 0.0 |
| Elvacite 2016 | 20.0 | 20.0 | 20.0 |
| Mondur M | 21.6 | 22.4 | 23.0 |

The formulations were tested for reactive hot melt properties.

Viscosity was tested on a Brookfield DV-I+viscometer using a #27 spindle. The temperature used was 250° F.

Green strength was tested by the dynamic peel method. First, a molten adhesive film was drawn on a heated glass plate. A one inch wide vinyl strip was then rolled onto the molten adhesive film. The glass plate was placed horizontally on two racks and a 103-gram weight was attached to one end of the vinyl strip. The distance that the vinyl peels from the glass plate was measured as a function of time as the adhesive cooled down to room temperature. In this test, the slower the vinyl peels from the glass (i.e., the lower the peeling rate), the higher the green strength of the adhesive.

Open time was tested by the lap shear method. Adhesive was coated on particle board and high pressure laminate strips were then mated on the adhesive at the desired open times. The bonds were allowed to cure for 24 hours before being examined on an Instron machine at 0.5 in/min crosshead speed. Failure mode and failure strength in psi unit were recorded. Open time was defined as the longest time during which substrate failure and/or cohesive failure was observed.

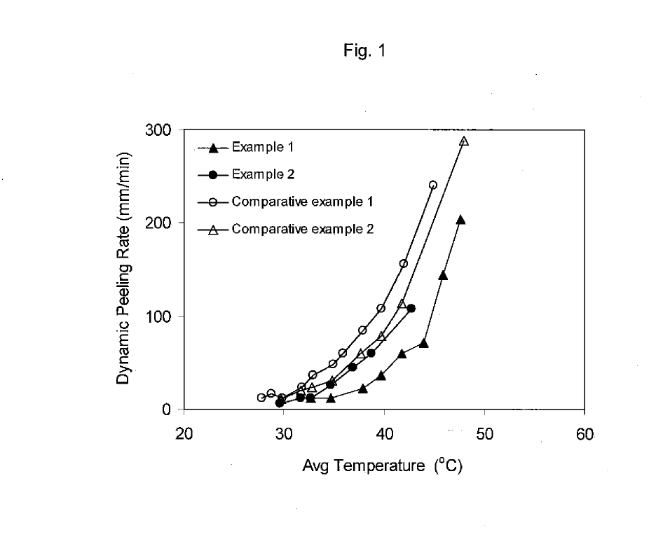

The results of the testing are shown in Table 2 and in FIG. 1.

TABLE 2

| | Viscosity @ | Open time |
|---|---|---|
| | 120° C. (cp) | (mins) |
| Example 1 | 9350 | ≧30 |
| Example 2 | 6380 | ≧30 |
| Comparative Example 1 | 4940 | ≧30 |
| Comparative Example 2 | 13000 | ≧30 |

As shown in Table 2 and FIG. 1, the formulations containing functionally modified polyolefin provide advantageous reactive hot melt properties, such as improved green strength at low viscosity, with desirable open time. In FIG. 1, the lower the peel rate the higher the green strength of the adhesive. A lower peel rate is better since it indicates a higher resistance to peeling forces.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

We claim:

1. A moisture reactive hot melt adhesive composition prepared from an isocyanate, a polyol selected from a linear polyether containing substantially no functional group other than hydroxyl groups, a branched polyether containing substantially no functional group other than hydroxyl groups, a polyoxyalkylene polyol, a homopolymer or a copolymer of a polyoxyalkylene polyol, a polyisobutylene diol, a polyamide polyol, a fatty polyol, castor oil, and mixtures thereof, and a multifunctionally modified polyolefin other than a silyl modified polyolefin.

2. The reactive hot melt adhesive of claim 1, wherein the multifunctionally modified polyolefin is a polyolefin with a reactive moiety selected from the group consisting of hydroxyl, carboxyl, thiol, amino, epoxy, and mixtures thereof.

3. The reactive hot melt adhesive of claim 1, wherein the multifunctionally modified polyolefin is an oxidized polyethylene.

4. The reactive hot melt adhesive of claim 1 prepared using a thermoplastic material.

5. The reactive hot melt adhesive of claim 1 further comprising a defoamer, a plasticizer, a compatible tackifier, a UV stabilizer, an antioxidant, a wax, an adhesion promoter, a filler, a thixotropic agent, a curing catalyst or mixture thereof.

6. The adhesive of claim 1 which has been cured by exposure to moisture.

7. An article of manufacture comprising the cured adhesive of claim 6.

8. A process for manufacturing an article, comprising applying the adhesive of claim 1 to a substrate surface and bringing a second substrate surface in contact with said first substrate surface.

9. The reactive hot melt adhesive of claim 1, wherein the multifunctionally modified polyolefin is an oxidized polyethylene and further comprising a thermoplastic material.

10. The reactive hot melt adhesive of claim 1, wherein the a polyol is a linear and/or branched polyether having hydroxyl groups, and containing substantially no functional group other than the hydroxyl groups.

11. The reactive hot melt adhesive of claim 1, wherein the polyol is a polyoxyalkylene polyol or a homopolymer or a copolymer of a polyoxyalkylene polyol.

12. The moisture reactive hot melt adhesive composition of claim 1 wherein the polyol is selected from a linear polyether polyol containing substantially no functional group other than the hydroxyl groups; a branched polyether polyol containing substantially no functional group other than the hydroxyl groups; a polyoxyalkylene polyol; a homopolymer or a copolymer of a polyoxyalkylene polyol; or a mixture thereof.

13. A moisture reactive, hot melt adhesive composition prepared from a mixture comprising an isocyanate; a polyol selected from at least one of a linear polyether polyol containing substantially no functional group other than hydroxyl groups, a branched polyether polyol containing substantially no functional group other than hydroxyl groups, a polyoxyalkylene polyol, a homopolymer or a copolymer of a polyoxyalkylene polyol, a polyisobutylene diol, a polyamide polyol and a fatty polyol; and a multifunctionally modified polyolefin other than a silyl modified polyolefin.

14. The moisture reactive, hot melt adhesive composition of claim 13 wherein the mixture further comprises a thermoplastic material.

15. The moisture reactive, hot melt adhesive composition of claim 13 wherein the multifunctionally modified polyolefin is oxidized polyethylene and/or has a reactive moiety selected from at least one of hydroxyl and carboxyl.

16. A moisture reactive, hot melt adhesive composition prepared from a mixture comprising an isocyanate; a polyol selected from at least one of a linear polyether containing substantially no functional group other than hydroxyl groups, a branched polyether containing substantially no functional group other than hydroxyl groups, a polyoxyalkylene polyol, a homopolymer or a copolymer of a polyoxyalkylene polyol, a polybutadiene polyol, a polyisobutylene diol, a polyamide polyol and a fatty polyol; oxidized polyethylene; and optionally a thermoplastic material.

17. A moisture reactive hot melt adhesive composition having an open time greater than or equal to 30 minutes and comprising a reaction product of a mixture consisting essentially of an isocyanate, a polyol selected from a linear polyether containing substantially no functional group other than hydroxyl groups, a branched polyether containing substantially no functional group other than hydroxyl groups, a polyoxyalkylene polyol, a homopolymer or a copolymer of a polyoxyalkylene polyol, a polyisobutylene diol, a polyamide polyol, a fatty polyol, castor oil, and mixtures thereof, and a multifunctionally modified polyolefin other than a silyl modified polyolefin.
